(19) United States
(12) Patent Application Publication
(10) Pub. No.: US 2025/0104905 A1
(43) Pub. Date: Mar. 27, 2025

(54) COIL COMPONENT

(71) Applicant: SAMSUNG ELECTRO-MECHANICS CO., LTD., Suwon-si (KR)

(72) Inventors: Boum Seock Kim, Suwon-si (KR); Sang Jin Kim, Suwon-si (KR); Byeong Cheol Moon, Suwon-si (KR); Han Lee, Suwon-si (KR); Chang Ryul Jung, Suwon-si (KR)

(73) Assignee: SAMSUNG ELECTRO-MECHANICS CO., LTD., Suwon-si (KR)

(21) Appl. No.: 18/784,116

(22) Filed: Jul. 25, 2024

(30) Foreign Application Priority Data
Sep. 22, 2023 (KR) 10-2023-0126742

(51) Int. Cl. H01F 27/29; H01F 17/00; H01F 27/32

(52) U.S. Cl. CPC H01F 27/292; H01F 17/0013; H01F 27/323

(57) ABSTRACT

A coil component includes a body including a first surface and a second surface opposing in a first direction, and a third surface and a fourth surface opposing in a second direction; a coil disposed in the body; a first lead-out electrode connected to an external end of the coil and drawn out to the first surface; a second lead-out electrode connected to an internal end of the coil and drawn out to the second surface; a first external electrode disposed on the third surface, extending to the first surface and connected to the first lead-out electrode; and a second external electrode disposed on the third surface, extending to the second surface and connected to the second lead-out electrode, wherein a thickness of each of the first and second lead-out electrodes in the second direction is smaller than a thickness of the coil in the second direction.

### CROSS-REFERENCE TO RELATED APPLICATION(S)

This application claims benefit of priority to Korean Patent Application No. 10-2023-0126742 filed on Sep. 22, 2023 in the Korean Intellectual Property Office, the disclosure of which is incorporated herein by reference in its entirety.

### TECHNICAL FIELD

The present disclosure relates to a coil component.

### BACKGROUND

An inductor, a coil component, may be a representative passive electronic component used in an electronic device along with a resistor and a capacitor.

As an electronic device has been designed to have high-performance and a reduced size, the number of electronic components used in an electronic device has increased and a size thereof has been reduced.

There has been a demand for a coil component having a single-layer coil structure which may be advantageous for thinning and reducing magnetic flux loss due to misalignment of coils.

### SUMMARY

An aspect of the present disclosure is to implement a coil component in which a central core area and an effective volume may increase by applying a single-layer coil structure, and loss of magnetic flux due to misalignment of coils may be reduced.

Another aspect of the present disclosure is to strengthen coupling force between a lead-out electrode and an external electrode and to reduce Rdc by expanding a contact area between the lead-out electrode and the external electrode.

According to an aspect of the present disclosure, a coil component includes a body including a first surface and a second surface opposing each other in a first direction, and a third surface and a fourth surface opposing each other in a second direction perpendicular to the first direction; a coil disposed in the body and forming at least one turn; a first lead-out electrode connected to an external end of the coil and drawn out to the first surface; a second lead-out electrode connected to an internal end of the coil and drawn out to the second surface; a first external electrode disposed on the third surface, extending to the first surface and connected to the first lead-out electrode; and a second external electrode spaced apart from the first external electrode on the third surface, extending to the second surface and connected to the second lead-out electrode, wherein a thickness of each of the first and second lead-out electrodes in the second direction is smaller than a thickness of the coil in the second direction.

### BRIEF DESCRIPTION OF DRAWINGS

The above and other aspects, features, and advantages of the present disclosure will be more clearly understood from the following detailed description, taken in conjunction with the accompanying lead-outs, in which:

FIG. 1 is a perspective diagram illustrating a coil component according to a first embodiment of the present disclosure;

FIG. 2 is an exploded perspective diagram illustrating a coupling relationship between a portion of components illustrated in FIG. 1;

FIG. 3 is a cross-sectional diagram taken along line I-I′ in FIG. 1;

FIG. 4 is a cross-sectional diagram taken along line II-II′ in FIG. 1;

FIG. 5 is a diagram illustrating a coil component according to a second embodiment of the present disclosure, corresponding to FIG. 3;

FIG. 6 is a diagram illustrating a coil component according to a third embodiment of the present disclosure, corresponding to FIG. 5; and

FIG. 7 is a diagram illustrating a coil component according to a fourth embodiment of the present disclosure, corresponding to FIG. 5.

### DETAILED DESCRIPTION

Hereinafter, embodiments of the present disclosure will be described as follows with reference to the attached drawings.

The present disclosure may, however, be exemplified in many different forms and should not be construed as being limited to the specific embodiments set forth herein. An expression used in the singular encompasses the expression of the plural, unless it has a clearly different meaning in the context. The terms, “include,” “comprise,” “is configured to,” or the like of the description are used to indicate the presence of features, numbers, steps, operations, elements, portions or combination thereof, and do not exclude the possibilities of combination or addition of one or more features, numbers, steps, operations, elements, portions or combination thereof. Also, the expression that an element is disposed “On” may indicate that the element may be disposed above or below a target portion, and does not necessarily indicate the element is disposed above the target portion in the direction of gravity.

It will be understood that when an element is “coupled with/to” or “connected with” another element, the element may be directly coupled with/to another element, and there may be an intervening element between the element and another element. To the contrary, it will be understood that when an element is “directly coupled with/to” or “directly connected to” another element, there is no intervening element between the element and another element.

The structures, shapes, and sizes described as examples in embodiments in the present disclosure may be implemented in another exemplary embodiment without departing from the spirit and scope of the present disclosure.

In the drawings, the L direction may be defined as a first direction or a length direction, the T direction may be defined as a second direction or a thickness direction, and the W direction may be defined as a third direction or a width direction.

In the drawings, the same elements will be indicated by same reference numerals. Also, redundant descriptions and detailed descriptions of known functions and elements that may unnecessarily render the gist of the present disclosure obscure will not be provided.

Various types of electronic components are used in electronic devices, and various types of coil components may be appropriately used between these electronic components for the purpose of removing noise.

That is, in electronic devices, a coil component may be used as a power inductor, a HF inductor, a general bead, a GHz bead, a common mode filter, or the like.

### First Embodiment

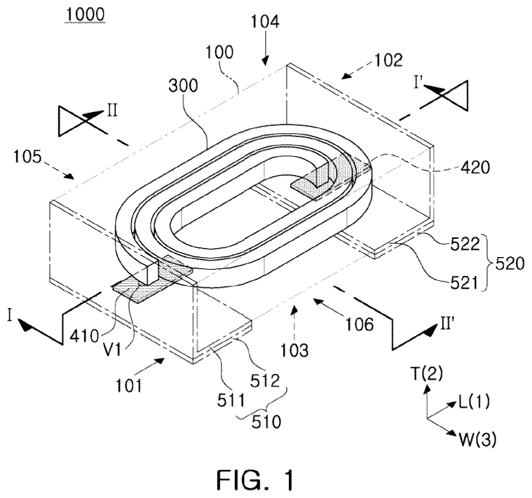

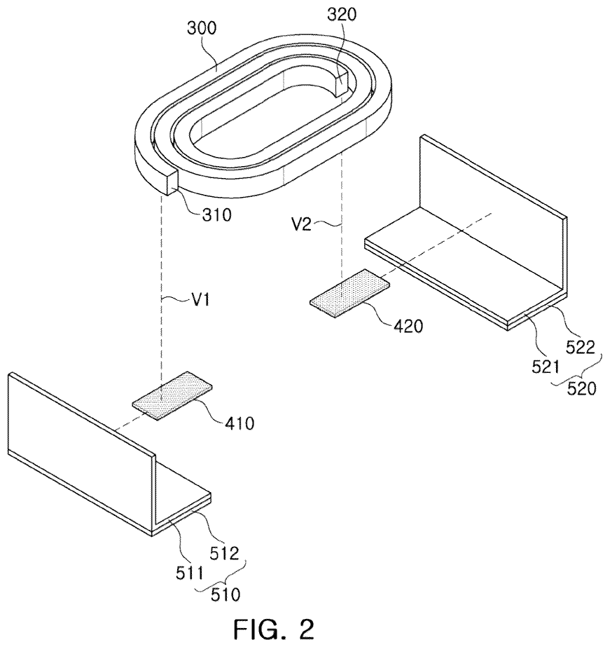

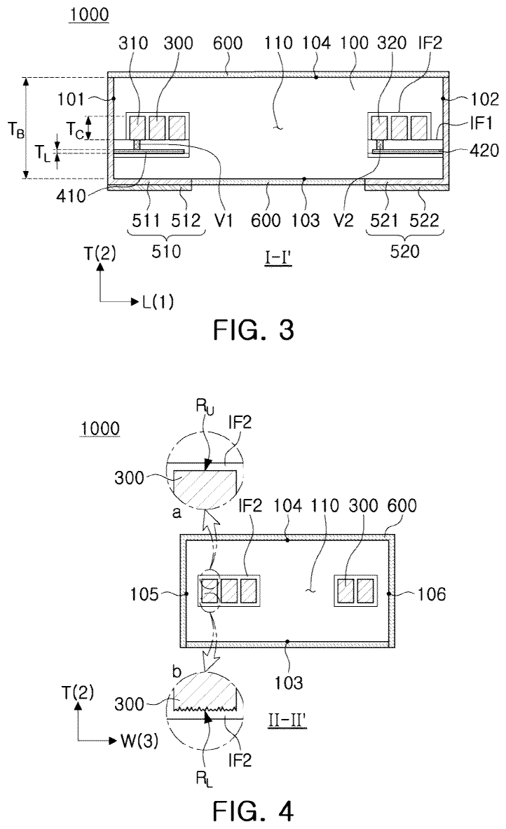

FIG. 1 is a perspective diagram illustrating a coil component 1000 according to a first embodiment. FIG. 2 is an exploded perspective diagram illustrating a coupling relationship between a portion of components illustrated in FIG. 1. FIG. 3 is a cross-sectional diagram taken along line I-I′ in FIG. 1. FIG. 4 is a cross-sectional diagram taken along line II-II′ in FIG. 1.

In FIG. 1, an insulating layer 600 on the body 100 applied to the embodiment will not be provided to allow a coupling relationship between the components to be represented clearly.

Referring to FIGS. 1 to 4, a coil component 1000 according to the first embodiment may include a body 100, a coil 300, lead-out electrodes 410 and 420, and external electrodes 510 and 520, and may further include an insulating layer 600 covering the body 100.

The coil component 1000 according to the embodiment may include the coil 300 disposed as a single layer in the body 100, and may include the lead-out electrodes 410 and 420 in the form of a plate connecting the coil 300 to the external electrodes 510 and 520.

The lead-out electrodes 410 and 420 may include bent portions 411 and 421 in end regions in contact with the external electrodes 510 and 520, and the bent portions 411 and 421 may be bent upwardly or downwardly along internal side surfaces of the external electrodes 510 and 520, thereby enhancing connection reliability and coupling force between the lead-out electrodes 410 and 420 and the external electrodes 510 and 520. Here, the bent portions 411 and 421 may be in direct contact with the internal side surfaces of the at least one of the external electrodes 510 and 520.

The coil component 1000 according to the embodiment may be advantageous for thinning as the coil component 1000 does not include support members such as a copper clad laminate (CCL board) for supporting the coil 300, and a space for a magnetic material to be disposed may be ensured within a limited size, thereby improving inductance.

Also, since the coil 300 is formed as a single layer, magnetic flux loss due to asymmetry or misalignment between upper and lower coils may be prevented as compared to the example in which two or more layers of coils are included.

In the description below, main components included in the coil component 1000 according to the embodiment will be described in greater detail.

The body 100 may form an exterior of the coil component 1000 in the embodiment, and the coil 300 may be disposed therein.

The body 100 may have a hexahedral shape.

The body 100 may include a first surface 101 and a second surface 102 opposing each other in the length direction L, a third surface 103 and a fourth surface 104 opposing each other in the thickness direction T, and a fifth surface 105 and a sixth surface 106 opposing each other in the width direction W. Each of the first to fourth surfaces 101, 102, 103 and 104 of the body 100 may be a wall surface of the body 100 connecting the third surface 103 and the fourth surface 104 of the body 100.

The body 100 may be formed such that the coil component in which the external electrodes 400 and 500 are formed may have a length of 2.5 mm, a width of 2.0 mm and a thickness of 0.8 mm, may have a length of 2.0 mm, a width of 1.2 mm and a thickness of 0.6 mm, may a length of 1.6 mm, a width of 0.8 mm and a thickness of 0.6 mm, may have a length of 1.6 mm, a width of 0.8 mm and a thickness of 0.6 mm, may have a length of 1.6 mm, a width of 0.8 mm and a thickness of 0.4 mm, may have a length of 1.4 mm, a width of 1.2 mm and a thickness of 0.65 mm, may have a length of 1.0 mm, a width of 0.7 mm and a thickness of 0.65 mm, may have a length of 0.8 mm, a width of 0.4 mm and a thickness of 0.65 mm, or may have a length of 0.8 mm, a width of 0.4 mm and a thickness of 0.5 mm, but an embodiment thereof is not limited thereto. As the above-described exemplary dimensions for the length, width and thickness of coil component 1000 may refer to dimensions not reflecting process errors, dimensions in the range recognized as process errors may correspond to the above-described example dimensions.

The length of the above-described coil component 1000 may be a maximum value among dimensions of a plurality of line segments connecting two outermost boundary lines of the coil component 1000, opposing each other in the length direction L, to each other and in parallel to the length direction L, with respect to an optical microscope image or a scanning electron microscope (SEM) image with respect to a cross-section in the length direction L-thickness direction T taken from the central portion of the coil component 1000 taken in the width direction W. Alternatively, the length of the coil component 1000 may refer to a minimum value among the dimensions of the plurality of line segments described above. Alternatively, the length of the coil component 1000 may refer to an arithmetic mean value of at least three or more of the dimensions of the plurality of line segments described above. Here, the plurality of line segments parallel to the length direction L may be spaced apart from each other by an equal distance in the thickness direction T, but an embodiment thereof is not limited thereto.

The thickness of the above-described coil component 1000 be a maximum value among dimensions of a plurality of line segments connecting two outermost boundary lines of the coil component 1000, opposing each other in the thickness direction T, to each other and in parallel to the thickness direction T, with respect to an optical microscope image or a scanning electron microscope (SEM) image with respect to a cross-section in the length direction L-thickness direction T taken from the central portion of the coil component 1000 taken in the width direction W. Alternatively, the thickness of the coil component 1000 may refer to a minimum value among the dimensions of the plurality of line segments described above. Alternatively, the thickness of the coil component 1000 may refer to an arithmetic mean value of at least three or more of the dimensions of the plurality of line segments described above. Here, the plurality of line segments parallel to the thickness direction T may be spaced apart from each other by an equal distance in the length direction L, but an embodiment thereof is not limited thereto.

The width of the above-described coil component 1000 may be a maximum value among dimensions of a plurality of line segments connecting two outermost boundary lines of the coil component 1000, opposing each other in the width direction W, to each other and in parallel to the width direction W, with respect to an optical microscope image or a scanning electron microscope (SEM) image with respect to a cross-section in the length direction L-width direction W taken from the central portion of the coil component 1000 taken in the thickness direction T. Alternatively, the width of the coil component 1000 may refer to a minimum value among the dimensions of the plurality of line segments described above. Alternatively, the width of the coil component 1000 may refer to an arithmetic mean value of at least three or more of the dimensions of the plurality of line segments described above. Here, the plurality of line segments parallel to the width direction W may be spaced apart from each other by an equal distance in the length direction L, but an embodiment thereof is not limited thereto.

Alternatively, each of the length, a width and thickness of the coil component 1000 may be measured by a micrometer measurement method. The micrometer measurement method may be of determining a zero point with a gage repeatability and reproducibility (R&R) micrometer, inserting the coil component 1000 in the embodiment between tips of the micrometer, and measuring by turning a measuring lever of a micrometer. In measuring the length of the coil component 1000 by the micrometer measurement method, the length of the coil component 1000 may refer to a value measured once or may refer to an arithmetic average of values measured a plurality of times, which may be equally applied to the width and thickness of the coil component 1000.

The body 100 may include a magnetic material and resin. Specifically, the body 100 may be formed by laminating one or more magnetic composite sheets in which a magnetic material is dispersed in an insulating resin. The body 100 may have a structure other than a structure in which a magnetic material is dispersed in resin. For example, the body 100 may be formed of a magnetic material such as ferrite.

The magnetic material may be ferrite or metallic magnetic powder.

A ferrite powder may be at least one of, for example, spinel-type ferrite such as Mg—Zn-based ferrite, Mn—Zn-based ferrite, Mn—Mg-based ferrite, Cu—Zn-based ferrite, Mg—Mn—Sr-based ferrite, Ni—Zn-based ferrite, hexagonal ferrites such as Ba—Zn-based ferrite, Ba—Mg-based ferrite, Ba—Ni-based ferrite, Ba—Co-based ferrite, Ba—Ni—Co-based ferrite, garnet-type ferrites such as Y-based ferrite, and Li-based ferrites.

Metal magnetic powder may include one or more selected from a group consisting of iron (Fe), silicon (Si), chromium (Cr), cobalt (Co), molybdenum (Mo), aluminum (Al), niobium (Nb), copper (Cu) and nickel (Ni). For example, the magnetic metal powder may be at least one of pure iron powder, Fe—Si alloy powder, Fe—Si—Al alloy powder, Fe—Ni alloy powder, Fe—Ni—Mo alloy powder, Fe—Ni—Mo—Cu alloy powder, Fe—Co alloy powder, Fe—Ni—Co alloy powder, Fe—Cr alloy powder, Fe—Cr—Si alloy powder, Fe—Si—Cu—Nb alloy powder, Fe—Ni—Cr-based alloy powder and Fe—Cr—Al alloy powder.

The metal magnetic powder may be amorphous or crystalline. For example, the magnetic metal powder may be a Fe—Si—B—Cr amorphous alloy powder, but an embodiment thereof is not limited thereto.

Each particle of ferrite and magnetic metal powder may have an average diameter of about 0.1 μm to 30 μm, but an embodiment thereof is not limited thereto.

The body 100 may include two or more types of magnetic materials dispersed in a resin. Here, the different types of magnetic materials may indicate that the magnetic materials dispersed in the resin may be distinguished from each other by one of an average diameter, composition, crystallinity, and shape.

The resin may include epoxy, polyimide, a liquid crystal polymer, or the like, alone or in combination but an embodiment thereof is not limited thereto.

Referring to FIGS. 3 and 4, the body 100 may include a core 110 disposed in a central region of the coil 300. The core 110 may be formed by filling a central region of the coil 300 with a magnetic composite sheet, but an embodiment thereof is not limited thereto.

The coil 300 may be embedded in the body 100 and may exhibit properties of the coil component. For example, when the coil component 1000 according to the embodiment is used as a power inductor, the coil 300 may function to stabilize power of an electronic device by storing an electric field as a magnetic field and maintaining an output voltage.

When the coil 300 is formed by plating, generally, coil patterns may be disposed on both surfaces of a board, respectively, and may be connected to each other by vias. However, in this structure, a region in which an upper coil pattern and a lower coil pattern do not overlap each other may be formed. Accordingly, loss of magnetic flux around the coil may occur, and the region in which the core region of the upper coil pattern and the core region of the lower coil pattern overlap may become the entire core region of the coil component, and the area of the entire core region may be reduced.

Differently from the above example, in the coil component 1000 according to the embodiment, the coil 300 may be formed in a single layer, such that loss of magnetic flux described above may be prevented and the area of the core 110 may also be increased.

Referring to FIGS. 1 to 4, the coil 300 may form at least one turn around the core 110 and may have a planar spiral shape, but an embodiment thereof is not limited thereto, and the coil 300 may also have an angled shape.

Referring to FIGS. 1, 2, and 3, the coil 300 may be disposed in the body 100 to be spaced apart from the surface. That is, the coil 300 may be disposed such that the fourth to sixth surfaces 104, 105, and 106 of the body 100 may be spaced apart from the first to third surfaces 101, 102, and 103, on which the external electrodes 510 and 520 are disposed.

Accordingly, the coil 300 may not be directly connected to the external electrodes 510 and 520, and may be electrically connected through the lead-out electrodes 410 and 420.

Referring to FIGS. 2 and 3, an external end 310 of the coil 300 may be connected to the first lead-out electrode 410, and an internal end 320 of the coil 300 may be connected to the second lead-out electrode 420.

Specifically, the external end 310 of the coil 300, that is, the end of the outermost turn, may be connected to the first lead-out electrode 410 through a first via V1, and the internal end 320 of the coil 300, that is, the end of the innermost turn, may be connected to the second lead-out electrode 420 through a second via V2.

Referring to FIGS. 1 to 3, the coil component 1000 according to the embodiment may include the lead-out electrodes 410 and 420.

The lead-out electrodes 410 and 420 may be components for connecting the single-layer coil 300 to the external electrodes 510 and 520, and to reduce a thickness of the coil component 1000, the lead-out electrodes 410 and 420 may have a thin plate shape as in the embodiment.

Referring to FIGS. 3 and 4, a thickness T_{L} in the second direction T of each of the first and second lead-out electrodes 410 and 420 may be smaller than a thickness T_{C} of the coil 300 in the second direction T.

As an example, the thickness T_{L} of the lead-out electrodes 410 and 420 in the embodiment may be 10 μm or more and 30 μm or less, but an embodiment thereof is not limited thereto. Also, the thickness T_{C} of the lead-out electrodes 410 and 420 may range from 2.7% to 8.0% of the thickness T_{B} of the body 100, but an embodiment thereof is not limited thereto.

When the thickness T_{L} of the lead-out electrodes 410 and 420 is less than 10 μm or is less than 2.7% of the thickness T_{B} of the body 100, reliability connection between the coil 300 and the external electrodes 510 and 520 may be reduced. Also, when the thickness T_{L} of the lead-out electrodes 410 and 420 exceeds 30 μm or exceeds 8.0% of the thickness T_{B} of the body 100, saturation current Iₛₐₜ properties may be reduced by 10% or more.

Here, the thickness T_{L} of the lead-out electrodes 410 and 420 may refer to, with respect to an optical microscope image or a scanning electron microscope (SEM) image of an L-T cross-section taken from a center of the coil component 1000 in the third direction W, an arithmetic average of at least three dimensions of dimensions of a plurality of line segments connecting boundaries between two outermost sides, opposing each other in the second direction T of the lead-out electrodes 410 and 420 in the image above, in parallel in the second direction T and spaced apart from each other in the first direction L. Here, the plurality of line segments parallel to the second direction T may be spaced apart from each other by an equal distance in the first direction L, but an embodiment thereof is not limited thereto.

A thickness T_{C} of the coil 300 and a thickness T_{B} of the body 100 may also be measured by the method described above.

Referring to FIGS. 2 and 3, the vias V1 and V2 may be components connecting the coil 300 to the lead-out electrodes 410 and 420.

Specifically, the coil component 1000 according to the embodiment may include a first via V1 connecting the external end 310 of the coil 300 to the first lead-out electrode 410, and a second via V2 connecting the internal end 320 of the coil 300 to the second lead-out electrode 420.

The first via V1 and the second via V2 may penetrate the first insulating film IF1 covering the lead-out electrodes 410 and 420.

Through the above-described components, a signal input to the first external electrode 510 may pass through the first lead-out electrode 410, the first via V1, the coil 300, the second via V2, and the second lead-out electrode 420 and may be output to the second external electrode 520. Accordingly, the first lead-out electrode 410, the first via V1, the coil 300, the second via V2, and the second lead-out electrode 420 may function as a single coil connected between the first and second external electrodes 510 and 520.

Referring to FIG. 4, the coil 300 may include one surface opposing the third surface 103 of the body 100, and the other surface opposing the fourth surface 104 of the body 100, and surface roughness R_{L} of one surface of the coil 300 may be greater than surface roughness Ru of the other surface.

The surface roughness may occur in the process of removing a support member of one surface of the coil 300 by a physical or chemical method after the coil 300 is formed by plating on the support member such as a CCL board. However, an embodiment thereof is not limited thereto, and a polishing process is added to one surface of the coil 300, a difference in surface roughness between one surface of the coil 300 and the other surface may not be observed.

The coil 300 in the embodiment may have increased coupling force with the second insulating film IF2 as the surface roughness R_{L} of one surface increases.

In embodiments, the surface roughness may refer to arithmetic average roughness Ra, and may be a value measured using an optical surface profiler such as a Zygo Corporation's 7300 Optical Surface Profiler, or using a Mitutoyo's surface roughness measuring device SV-3200. The above-described surface roughness may correspond to an arithmetic mean value of the values measured in the T-axis direction for the W-T cross-sectional surface passing through a center of one surface or the other surface of the coil 300.

At least one of the coil 300, the via V1 and V2, and the lead-out electrodes 410 and 420 may include one or more conductive layers. For example, when the coil 300 and the via V1 and V2 are formed by plating on a support member such as a CCL board, the coil 300 and each of the coil 300 and the via V1 and V2 may include a first conductive layer formed by electroless plating, and a second conductive layer disposed on the first conductive layer.

The first conductive layer may be a seed layer for forming a second conductive layer by plating on a support member such as a CCL board, and the second conductive layer may be an electroplating layer. Here, the electroplating layer may have a single layer structure or a multilayer structure. An electroplating layer having a multilayer structure may be formed as a conformal film structure in which one electroplating layer is covered by another electroplating layer, or may be formed in a shape in which another electroplating layer is laminated on only one surface of one electroplating layer. The seed layer of the coil 300 and the seed layers of the vias V1 and V2 may be integrally formed such that no boundary may be formed therebetween, but an embodiment thereof is not limited thereto. The electroplating layer of the coil 300 and the electroplating layers of via V1 and V2 may be integrally formed such that no boundary may be formed therebetween, but an embodiment thereof is not limited thereto.

Each of the coil 300, the via V1 and V2, the lead-out electrodes 410 and 420 may be formed of a conductive material such as copper (Cu), aluminum (Al), silver (Ag), tin (Sn), gold (Au), nickel (Ni), lead (Pb), titanium (Ti), or alloys thereof, but an embodiment thereof is not limited thereto.

Referring to FIGS. 3 and 4, the coil component 1000 according to the embodiment may further include insulating films IF1 and IF2 in the body 100.

In the embodiment, the insulating films IF1 and IF2 may be components covering the coil 300 and the lead-out electrodes 410 and 420. The insulating films IF1 and IF2 may insulate the coil 300 from the lead-out electrodes 410 and 420 in a region other than the via V1 and V2, and may insulate the coil 300 and the lead-out electrodes 410 and 420 from the body 100.

Referring to FIG. 3, the first insulating film IF1 in the embodiment may be disposed between the first lead-out electrode 410 and the coil 300, and may insulate the first lead-out electrode 410 and the coil 300.

Also, the first insulating film IF1 may be disposed between the second lead-out electrode 420 and the coil 300, and may insulate the second lead-out electrode 420 and the coil 300 from each other.

The coil component 1000 according to the embodiment may further include a second insulating film IF2 covering at least a portion of the coil 300 and the lead-out electrodes 410 and 420.

An interfacial surface may be formed between the first insulating film IF1 and the second insulating film IF2 in the embodiment according to a process order, but an embodiment thereof is not limited thereto, and the first insulating film IF1 and the second insulating film IF2 may be integrated with each other and an interfacial surface may not be formed.

The insulating films IF1 and IF2 may be formed of a thermosetting insulating resin such as an epoxy resin, a thermoplastic insulating resin such as polyimide, or an insulating material including a photosensitive insulating resin, or an insulating material in which the insulating resin is impregnated with a reinforcing material.

As a non-limiting example, the insulating films IF1 and IF2 may be formed of a film-type insulating material such as prepreg, Ajinomoto build-up film (ABF), and photo imaginable dielectric (PID) film, but an embodiment thereof is not limited thereto, and the insulating films IF1 and IF2 may be formed by applying a liquid insulating resin and curing the resin. Alternatively, the insulating films IF1 and IF2 may include a generally used insulating material such as parylene or polyimide, and may also be formed by a method such as a vapor deposition method.

Referring to FIGS. 1 and 3, the external electrodes 510 and 520 may be disposed on the body 100 and may be connected to lead-out electrodes 410 and 420.

Specifically, the first external electrode 510 may be disposed on the third surface 103 of the body 100, may extend to the first surface 101, and may be connected to the first lead-out electrode 410. Also, the second external electrode 520 may be disposed on the third surface 103 of the body 100, may extend to the second surface 102, and may be connected to the second lead-out electrode 420. The first external electrode 510 and the second external electrode 520 may be spaced apart from each other on the third surface 103 of the body 100.

The first external electrode 510 may include a connection portion disposed on the first surface 101 of the body 100 and connected to the first connection electrode 410, and a pad portion extending from the connection portion to the third surface 103 of the body 100. Also, the second external electrode 520 may include a connection portion disposed on the second surface 102 of the body 100 and connected to the second connection electrode 420, and a pad portion extending from the connection portion to the third surface 103 of the body 100.

The connection portion and the pad portion may be integrated with each other, but an embodiment thereof is not limited thereto.

The pad portion of the external electrodes 510 and 520 may be a component in contact with a connection member such as solder when the coil component 1000 is mounted on a circuit board, and may protrude further than the insulating layer 600 on the third surface 103 of the body 100. When the pad portion of the external electrodes 510 and 520 protrudes as in the embodiment, a contact area with a connection member such as solder may be widened when mounting the coil component 1000, such that adhesion strength may be strengthened, and a distance from a circuit board may also be increased, such that the risk of short circuit may be reduced.

The external electrode 510 and 520 may be formed of a conductive material such as copper (Cu), aluminum (Al), silver (Ag), tin (Sn), gold (Au), nickel (Ni), lead (Pb), titanium (Ti), or alloys thereof, but an embodiment thereof is not limited thereto.

Referring to FIGS. 1 and 3, the external electrodes 510 and 520 may be formed in a multilayer structure. For example, the first layer 511 and 521 on which the external electrodes 510 and 520 are connected to the lead-out electrodes 410 and 420 may be a copper (Cu) plating layer or a conductive resin layer including at least one of copper (Cu) or silver (Ag).

Here, when the first layers 511 and 521 of the external electrodes 510 and 520 are formed of a conductive resin layer, the first layers 511 and 521 may include resin and a metal dispersed in the resin, and the resin may be a thermosetting resin and may include an epoxy, and the metal may include at least one of silver (Ag) or copper (Cu). For example, the conductive resin layer may be an Ag-Epoxy layer or a Cu-Epoxy layer, and may be formed by applying and curing a conductive paste including at least one of silver (Ag) or copper (Cu), but an embodiment thereof is not limited thereto.

In the external electrodes 510 and 520 in the embodiment, second layers 512 and 522 may be additionally disposed to cover a region of the first layers 511 and 521, disposed on the third surface 103 of the body 100. That is, the second layers 512 and 522 may be included in the pad portion in direct contact with solder when the coil component 1000 is mounted on the circuit board.

The second layers 512 and 522 of the external electrodes 510 and 520 may have a double-layer structure of a nickel (Ni) plating layer and a tin (Sn) plating layer.

The first layers 511 and 521 of the external electrodes 510 and 520 may be formed by electroplating, vapor deposition such as sputtering, or may be formed by applying and curing a conductive paste including conductive powder such as copper (Cu) and/or silver (Ag), and the second layers 512 and 522 may be formed by electroplating.

Referring to FIGS. 3 and 4, the coil component 1000 according to the embodiment may further include an insulating layer 600 disposed on the body 100 and exposing the external electrodes 510 and 520.

The insulating layer 600 may be disposed to cover the third surface to sixth surface 103, 104, 105, and 106 of the body 100, and may be disposed in a region between the first external electrode 510 and the second external electrode 520 on the third surface 103 of the body 100 and may expose the first and second external electrodes 510 and 520.

The insulating layer 600 in the embodiment may be formed to have a thickness smaller than that of the external electrodes 510 and 520, and in this case, the external electrodes 510 and 520 may have a shape partially protruding toward the mounting surface. For example, external side surfaces of the second layers 512 and 522 of the external electrodes 510 and 520 may protrude further than an external side surface of the insulating layer 600.

When the external electrodes 510 and 520 are disposed to protrude further than the insulating layer 600, a contact area with a connection member such as solder may be widened when mounting the coil component 1000, such that adhesion strength may be strengthened and a distance from a circuit board may also be increased, thereby reducing the risk of short circuit.

For example, the insulating layer 600 may be formed by applying and curing an insulating material including an insulating resin to the surface of the body 100. In this case, the insulating layer 600 may include at least one of thermoplastic resins such as polystyrene resin, vinyl acetate resin, polyester resin, polyethylene resin, polypropylene resin, polyamide resin, rubber resin, and acrylic resin, thermosetting resins such as phenolic resin, epoxy resin, urethane resin, melamine resin, alkyd resin, or the like, and photosensitive resin.

### Second Embodiment

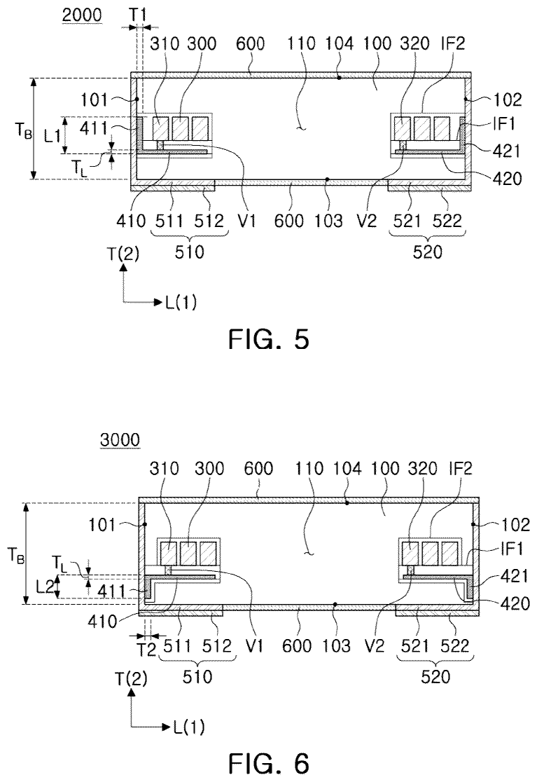

FIG. 5 is a diagram illustrating a coil component 2000 according to a second embodiment, corresponding to FIG. 3.

Comparing FIG. 5 with FIG. 3, the configuration in which the lead-out electrodes 410 and 420 include bent portions 411 and 421 may be different.

Accordingly, in describing the embodiment, only the bent portions 411 and 421 included in the lead-out electrodes 410 and 420, which are different from the first embodiment, will be described. The description in the first embodiment may be applied to the other components in the embodiment.

Referring to FIG. 5, the bent portions 411 and 421 in the embodiment may be formed in a region in which the lead-out electrodes 410 and 420 are drawn out from the body 100.

The bent portions 411 and 421 in the embodiment may be disposed to be bent toward the fourth surface 104 of the body 100. Specifically, the lead-out electrodes 410 and 420 may include the bent portions 411 and 421 formed parallel to the first direction L and bent in the second direction T to be directed to the fourth surface 104 of the body 100 in a region adjacent to the first surface 101 or the second surface 102 of the body 100.

The bent portions 411 and 421 in the embodiment may extend toward the fourth surface 104 of the body 100 in the second direction T along internal side surfaces of the external electrodes 510 and 520.

Specifically, the first bent portion 411 may be formed on an end on which the first lead-out electrode 410 is in contact with the first surface 101 of the body 100, and extend along an internal side surface of the first external electrode 510 toward the fourth surface 104 of the body 100 in the second direction T.

Also, the second bent portion 421 may be formed on an end on which the second lead-out electrode 420 is in contact with the second surface 102 of the body 100, and may extend in the second direction T along an internal side surface of the second external electrode 520 toward the fourth surface 104 of the body 100.

A thickness T1 of the bent portions 411 and 421 extending in the second direction T may be greater than a thickness T_{L} of the lead-out electrodes 410 and 420 parallel to the first direction L, but an embodiment thereof is not limited thereto.

A length L1 of the bent portions 411 and 421 of the embodiment may be, for example, 30 μm or more and 110 μm or less, but an embodiment thereof is not limited thereto. Also, the length L1 of the bent portions 411 and 421 may range from 8.0% to 29.3% of the thickness T_{B} of the body 100, but an embodiment thereof is not limited thereto.

When the length L1 of the bent portions 411 and 421 is less than 30 μm or less than 8.0% of the thickness T_{B} of the body 100, connection reliability between the coil 300 and the external electrodes 510 and 520 may be reduced. Also, when the length L1 of the bent portions 411 and 421 exceeds 110 μm or exceeds 29.3% of the thickness T_{B} of the body 100, inductance Ls properties may be reduced by 10% or more.

Here, the length L1 of the bent portion 411 and 421 may refer to, with respect to an optical microscope image or a scanning electron microscope (SEM) image of an L-T cross-section taken from a center of the coil component 1000 in the third direction W, an arithmetic average of at least three dimensions of dimensions of a plurality of line segments connecting boundaries between two outermost sides, opposing each other in the second direction T of the bent portion 411 and 421 in the image above, in parallel in the second direction T and spaced apart from each other in the first direction L. Here, the plurality of line segments parallel to the second direction T may be spaced apart from each other by an equal distance in the first direction L, but an embodiment thereof is not limited thereto.

Since the bent portions 411 and 421 in the embodiment are components of the lead-out electrodes 410 and 420, the bent portions 411 and 421 may be formed of a conductive material such as copper (Cu), aluminum (Al), silver (Ag), tin (Sn), gold (Au), nickel (Ni), lead (Pb), titanium (Ti).

The bent portions 411 and 421 in the embodiment may be formed by forming a region parallel to the first direction L of the lead-out electrodes 410 and 420, disposing a dam mask for exposing a region in which the bent portions 411 and 421 are be disposed, and performing electrolytic plating, but an embodiment thereof is not limited thereto.

In the coil component 2000 according to the embodiment, a contact area between the lead-out electrodes 410 and 420 and the external electrodes 510 and 520 may increase through the bent portions 411 and 421, and connection reliability and coupling force between the lead-out electrodes 410 and 420 and the external electrodes 510 and 520 may be strengthened, and Rdc may be reduced.

### Third Embodiment

FIG. 6 is a diagram illustrating a coil component 3000 according to a third embodiment, corresponding to FIG. 5.

Comparing FIG. 6 with FIG. 5, the bent direction and the shape of the bent portions 411 and 421 included in the lead-out electrodes 410 and 420 may be different.

Accordingly, in describing the embodiment, only the bent direction and the shape of the bent portions 411 and 421, which are different from the second embodiment, will be described. The description in the first embodiment may be applied to the other components in the embodiment.

Referring to FIG. 6, the bent portions 411 and 421 in the embodiment may be disposed in a bent shape, bent toward the third surface 103 of the body 100. Specifically, the lead-out electrodes 410 and 420 may include the bent portions 411 and 421 formed parallel to the first direction L and bent in the second direction T toward the third surface 103 of the body 100 in a region adjacent to the first surface 101 or the second surface 102 of the body 100.

The bent portions 411 and 421 in the embodiment may extend toward the third surface 103 of the body 100 in the second direction T along internal side surfaces of the external electrodes 510 and 520.

Specifically, the first bent portion 411 may be formed an end on which the first lead-out electrode 410 is in contact with the first surface 101 of the body 100, and may extend along an internal side surface of the first external electrode 510 toward the third surface 103 of the body 100 in the second direction T.

Also, the second bent portion 421 may be formed on an end on which the second lead-out electrode 420 is in contact with the second surface 102 of the body 100, and may extend toward the third surface 103 of the body 100 in the second direction T along an internal side surface of the second external electrode 520.

The thickness T2 of the bent portions 411 and 421 extending in the second direction T may be greater than the thickness T_{L} of the lead-out electrodes 410 and 420 parallel to the first direction L, but an embodiment thereof is not limited thereto.

A length L2 of the bent portions 411 and 421 in the embodiment may be, for example, 30 μm or more and 110 μm or less, but an embodiment thereof is not limited thereto. Also, the length L2 of the bent portions 411 and 421 may range from 8.0% to 29.3% of the thickness T_{B} of the body 100, but an embodiment thereof is not limited thereto.

When the length L2 of the bent portions 411 and 421 is less than 30 μm or less than 8.0% of the thickness T_{B} of the body 100, connection reliability between the coil 300 and the external electrodes 510 and 520 may be reduced. Also, when the length L2 of the bent portions 411 and 421 exceeds 110 μm or exceeds 29.3% of the thickness T_{B} of the body 100, inductance Ls properties may be reduced by more than 10%.

Here, the length L2 of the bent portions 411 and 421 may refer to, with respect to an optical microscope image or a scanning electron microscope (SEM) image of an L-T cross-section taken from a center of the coil component 1000 in the third direction W, an arithmetic average of at least three dimensions of dimensions of a plurality of line segments connecting boundaries between two outermost sides, opposing each other in the second direction T of the bent portion 411 and 421 in the image above, in parallel in the second direction T and spaced apart from each other in the first direction L. Here, the plurality of line segments parallel to the second direction T may be spaced apart from each other by an equal distance in the first direction L, but an embodiment thereof is not limited thereto.

In the coil component 3000 according to the embodiment, the bent portions 411 and 421 may be bent toward the external electrodes 510 and 520 disposed on the third surface 103 of the body 100, such that the effect of partially shielding an area between coil 300 and the mounting surface may be advantageous in terms of saturation current Iₛₐₜ properties.

### Fourth Embodiment

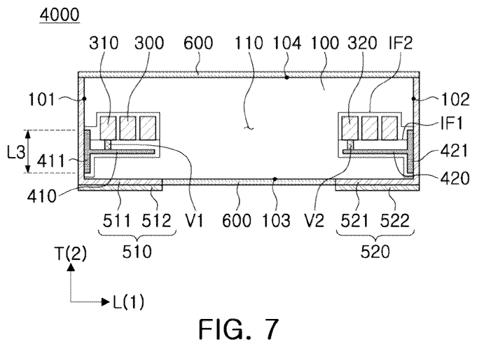

FIG. 7 is a diagram illustrating a coil component according to a fourth embodiment, corresponding to FIG. 5.

Comparing FIG. 7 with FIG. 5, the bent direction and the shape of the bent portions 411 and 421 included in the lead-out electrodes 410 and 420 may be different.

Accordingly, in describing the embodiment, only the bent direction and the shape of the bent portions 411 and 421, which are different from the second embodiment, will be described. The description in the first embodiment may be applied to the other components in the embodiment.

Referring to FIG. 7, the bent portions 411 and 421 in the embodiment may extend in the second direction T toward the third surface 103 and the fourth surface 104 of the body 100.

Specifically, the lead-out electrodes 410 and 420 may include bent portions 411 and 421 formed parallel to the first direction L and extending in the second direction T toward the third surface 103 and the fourth surface 104 of body 100, respectively, in regions adjacent to the first surface 101 or the second surface 102 of the body 100.

The bent portions 411 and 421 in the embodiment may extend in the second direction T along internal side surfaces of the external electrodes 510 and 520 toward the third surface 103 and the fourth surface of the body 100, respectively. That is, the bent portions 411 and 421 in the embodiment may extend in both directions.

Specifically, the first bent portion 411 may be formed on an end on which the first lead-out electrode 410 is in contact with the first surface 101 of the body 100, and may extend in the second direction T along an internal side surface of the first external electrode 510 toward the third surface 103 and the fourth surface 104 of the body 100, respectively.

Also, the second bent portion 421 may be formed on an end on which the second lead-out electrode 420 is in contact with the second surface 102 of the body 100, and may extend in the second direction T along an internal side surface of the second external electrode 520 toward the third surface 103 and the fourth surface 104 of the body 100, respectively.

Since the bent portions 411 and 421 in the embodiment extend in both directions, a length L3 of the bent portions 411 and 421 in the embodiment may be longer than a length L2 of the bent portions 411 and 421 in the second embodiment.

In the coil component 4000 according to the embodiment, the bent portions 411 and 421 may extend in both directions and the length L3 of the bent portions 411 and 421 may be formed to be relatively long, and accordingly, a contact area with the external electrodes 510 and 520 may increase, such that connection reliability and coupling force between the coil 300 and the external electrodes 510 and 520 may be strengthened.

Also, a portion of regions of the bent portions 411 and 421 may extend toward a mounting surface and may have the effect of partially shielding an area between the coil 300 and the mounting surface, which may be advantageous in terms of saturation current Iₛₐₜ properties.

According to the aforementioned embodiments, by applying a single-layer coil structure to a thin-film coil component, a central core area and an effective volume may be increased, and magnetic flux loss due to misalignment of coils may be reduced.

According to another aspect, by widening a contact area between the lead-out electrode and the external electrode, coupling force between the lead-out electrode and the external electrode may be strengthened, and a coil component with reduced Rdc may be provided.

While the embodiments have been illustrated and described above, it will be apparent to those skilled in the art that modifications and variations could be made without departing from the scope of the present disclosure as defined by the appended claims.

What is claimed is:

1. A coil component, comprising:
a body including a first surface and a second surface opposing each other in a first direction, and a third surface and a fourth surface opposing each other in a second direction perpendicular to the first direction;
a coil disposed in the body and including at least one turn;
a first lead-out electrode connected to an external end of the coil and drawn out to the first surface;
a second lead-out electrode connected to an internal end of the coil and drawn out to the second surface;
a first external electrode disposed on the third surface, extending onto the first surface and connected to the first lead-out electrode; and
a second external electrode spaced apart from the first external electrode on the third surface, extending onto the second surface and connected to the second lead-out electrode,
wherein a thickness of each of the first and second lead-out electrodes in the second direction is smaller than a thickness of the coil in the second direction.

2. The coil component of claim 1, wherein at least one of the first and second lead-out electrodes includes a bent portion formed in a region drawn out from the body.

3. The coil component of claim 2, wherein the bent portion is bent toward the fourth surface.

4. The coil component of claim 2, wherein the bent portion is bent toward the third surface.

5. The coil component of claim 2, wherein the bent portion extends in the second direction toward the third surface and the fourth surface.

6. The coil component of claim 2, wherein the bent portion extends in the second direction along internal side surfaces of the at least one of the first and second external electrodes.

7. The coil component of claim 6, wherein a thickness of the bent portion in the first direction is greater than a thickness of the at least one of the first and second lead-out electrodes in the second direction.

8. The coil component of claim 1,
wherein the first and second lead-out electrodes are covered by a first insulating film, and
wherein the first insulating film is disposed between the first lead-out electrode and the coil, and between the second lead-out electrode and the coil.

9. The coil component of claim 8, further comprising:
a first via connecting the external end of the coil to the first lead-out electrode; and
a second via connecting the internal end of the coil to the second lead-out electrode.

10. The coil component of claim 9, wherein the first and second vias penetrate the first insulating film.

11. The coil component of claim 8, further comprising:
a second insulating film covering at least a portion of the coil and the at least a portion of the first and second lead-out electrodes.

12. The coil component of claim 11, wherein the first insulating film and the second insulating film are integrated with each other.

13. The coil component of claim 1,
wherein the coil includes one surface opposing the third surface, and another surface opposing the fourth surface, and
wherein surface roughness of the one surface is greater than surface roughness of the other surface.

14. The coil component of claim 2, wherein a length of the bent portion in the second direction is 30 μm or more and 110 μm or less.

15. The coil component of claim 2, wherein the length of the bent portion in the second direction ranges from 8.0% to 29.3% of a thickness of the body in the second direction.

16. The coil component of claim 6, wherein the bent portion is in direct contact with the internal side surfaces of the at least one of the first and second external electrodes.

17. The coil component of claim 1, wherein the body further includes a fifth surface and a sixth surface opposing each other in a third direction perpendicular to the first direction and the second direction,
an insulating layer is disposed to cover the fourth, fifth, and sixth surfaces of the body and to cover a portion of the third surface between the first and second external electrodes on the third surface of the body to expose the first and second external electrodes, and
the first and second external electrodes protrude further than an external side surface of the insulating layer disposed on the third surface of the body.

18. The coil component of claim 1, wherein the body is free of a support member for supporting the coil.

19. The coil component of claim 1, wherein the coil is formed as a single layer.
